(19) United States
(12) Patent Application Publication
(10) Pub. No.: US 2004/0095886 A1
(43) Pub. Date: May 20, 2004

(54) Program placement method, packet transmission apparatus, and terminal

(75) Inventors: Ken Nakaoka, Ichinomiya-shi (JP); Masami Kato, Gifu (JP)

Correspondence Address: McDERMOTT, WILL & EMERY, 600 13th Street, N.W., Washington, DC, 20005-3096, US

(73) Assignee: SANYO ELECTRIC CO., LTD.

(21) Appl. No.: 10/705,886

(22) Filed: Nov. 13, 2003

(30) Foreign Application Priority Data
Nov. 15, 2002 (JP) JP2002-332058

(51) Int. Cl. H04L 12/26

(52) U.S. Cl. 370/236

(57) ABSTRACT

A terminal for uploading a program to a network node is provided. A request message generation unit generates a node information request message and the message is sent to a plurality of nodes on a communication path. Node information response messages are received from the plurality of the nodes and stored in a node information storage. An active node decision unit decides active nodes according to the node information response messages from the nodes and stores a list of the active nodes in an active node list storage. A program upload unit refers to the active node list and performs a process for uploading a predefined program stored in a program storage to each active node.

### BACKGROUND OF THE INVENTION

1. Field of the Invention

The present invention relates to an active network technology, and it particularly relates to a method for placing a program in a network node, and a packet transmission apparatus and a terminal using the method.

2. Description of the Related Art

Since the use of broadband networks has been common among general users, network resource consuming services become popular, such as peer-to-peer real time communication using image and audio, a streaming distribution using video and so on. As a result, the users' awareness about quality of the network services has been raised and the users become very sensitive to quality degradation. Therefore, a guarantee of Quality of Service (QoS) has been strongly requested for the Internet that has offered best effort services. Besides personal computers, mobile phones and mobile terminals are commonly used as a new means for utilizing the networks, and therefore it is also necessary that a flexible service should be offered according to the type of communication of the terminals. In such situations, a network node such as a router, a switch, or the like has been expected not only to perform a simple packet transmission process but also to have a kind of intelligence in consideration of an application layer.

The terminal to access the networks can easily undergo a model change according to various needs of the users or a new network technology and the cycle of the model change becomes short. On the other hand, since guarantee of connectivity and compatibility with the old models are required in the case of a router or a switch and standardization is necessary for changing the specifications, it takes a long time to conform to a new technology. It is difficult to immediately conform to the requirements of a great variety of network services. As a technology by which the functions of the networks can be flexibly changed, a concept of an active network has been proposed, for instance, in the reference [1]. The active network can flexibly control the behavior of the network by locating a program in a network node. Since by adopting the mechanism of the active network, they can introduce new service functions into a network system at an early stage without spending time and costs for standardization, the industrial world as well as the academic have expected much of the active network.

In order to meet the user's request for the quality, the active network places a program for performing a specific process on packets, which are sent and received by the terminal, in a specific network node of the active network. The node in which such a specific program is placed is called an active node. A method by which the number and the location of such active nodes are optimized has been proposed. For instance, see the reference [2].

For the effective use of the active network, a problem is which network node a program is placed in. If the program is placed in a node with a heavy processing load, the transmission of the packets is delayed and the service quality could be degraded against the user's expectations. In addition, the terminals may access to the network in various ways and wireless access points as well as wired ones may be used. Therefore, even if a node in the wired network is set as an active node, the degradation of the service quality might occur at the boundary between the wireless and wired networks and the expected effect could not be obtained. Thus, in order to determine which node places a program therein as an active node, network congestion and access environment must be considered and it is difficult to determine it uniformly by a simple rule.

### Related Art List

[1] Miki Yamamoto, “A Survey of Active Network Technology”, IEICE Transactions on Communications, Vol. J84-B, No.8, pp.1401-1412, August 2001.

[2] JP 2001-249910 A

### SUMMARY OF THE INVENTION

The present invention has been made based on these considerations, and an object thereof is to provide a network technology which can determine an appropriate network node to be an active node and place a program in the active node.

According to one aspect of the present invention, a terminal is provided. The terminal comprises a sending unit which sends a request message for node information to a plurality of network nodes on a communication path; a receiving unit which receives a response message including the node information from each of the network nodes which have received the request message; a decision unit which decides on at least one of the plurality of the network nodes to be an active node according to the response message; and an upload unit which uploads to the active node a program for performing a specific process on packets to be sent or received by the terminal.

According to another aspect of the present invention, a packet transmission apparatus is provided. The apparatus comprises a decision unit which decides whether to be an active node for the terminal in receiving a decision request message for an active node from a terminal; a receiving unit which receives from the terminal a program for performing a specific process on packets to be sent or received by the terminal when the decision unit decides to be an active node; a storage which stores the received program; and an execution unit which executes the stored program by incorporating the program into a packet processing.

The packet transmission apparatus may be a network node such as a router, a switch, a wireless access point, or the like, and the apparatus may have an environment for executing a specific packet processing according to a program for an active node.

According to still another aspect of the present invention, a program placement method is provided. The method comprises collecting node information from a plurality of network nodes on a communication path of packets to be sent or received by a terminal; deciding on at least one of the plurality of the network nodes to be an active node according to the collected node information; and uploading to the active node a program for performing a specific process on packets to be sent or received by the terminal. The terminal according to the above-mentioned aspect of the present invention can utilize this method.

According to still another aspect of the present invention, a program placement method is also provided. The method comprises receiving requirement information on packet communication of a terminal at a node on a communication path of packets to be sent or received by the terminal; deciding whether to be an active node for the terminal according to the requirement information; and receiving from the terminal a program for performing a specific process on packets to be sent or received by the terminal and incorporating the received program into a packet processing if it is decided to be an active node. The packet transmission apparatus according to the above-mentioned aspect of the present invention can utilize this method.

Moreover, any arbitrary replacement or substitution of the above-described structural components and the steps, expressions replaced or substituted in part or whole between a method and an apparatus as well as addition thereof, and expressions changed to a system, a computer program, a storage medium, a transmission medium or the like are all effective as and are encompassed by the present invention.

This summary of the invention does not necessarily describe all necessary features, so that the invention may also be a sub-combination of these described features.

### BRIEF DESCRIPTION OF THE DRAWINGS

FIG. 1 shows a structure of an active network according to an embodiment.

FIG. 2 is a block diagram of the terminal of FIG. 1.

FIG. 3 is a block diagram of the packet transmission apparatus of FIG. 1.

FIG. 4 is a flowchart showing a procedure employed by the terminal of FIG. 1 for deciding an active node and uploading a program.

FIG. 5 is a flowchart showing a procedure by the packet transmission apparatus of FIG. 1 for deciding whether to be an active node and receiving an uploaded program.

### DETAILED DESCRIPTION OF THE INVENTION

The invention will now be described by reference to the preferred embodiments. This does not intend to limit the scope of the present invention, but to exemplify the invention.

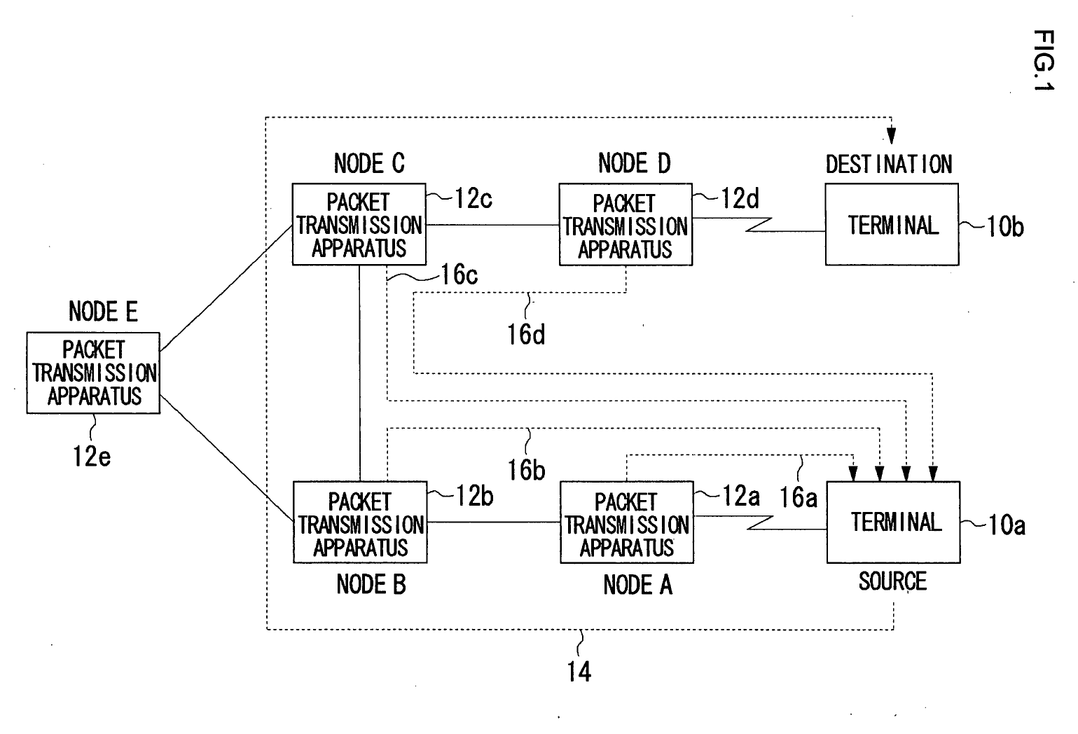

FIG. 1 shows a structure of an active network according to an embodiment. The packet transmission apparatus 12a to 12e are provided on the nodes A to E of the active network. The source terminal 10a connects with the packet transmission apparatus 12a on the node A by wireless and exchanges data with the destination terminal 10b. The destination terminal 10b connects with the packet transmission apparatus 12d on the node D by wireless. The packet transmission apparatus 12a and 12d on the nodes A and D are wireless access points, whereas the packet transmission apparatus 12b, 12c and 12e on the nodes B, C and E are routers interconnected via a wired network. The terminal 10a and 10b are, for instance, personal computers, portable electronic devices such as PDA (Personal Data Assistant), mobile phones with data communication function, or the like.

The source terminal 10a sends a node information request message 14 to the destination terminal 10b in order to collect network node information. The node information request message 14 is received in the packet transmission apparatus 12a, 12b, 12c and 12d provided on the nodes A, B, C and D on the communication path. The packet transmission apparatus 12a, 12b, 12c and 12d, which have received the packet information request message 14, send node information response messages 16a, 16b, 16c and 16d respectively back to the source terminal 10a.

The source terminal 10a collects these node information response messages, and thereby decides on at least one of the plurality of the nodes A to D on the communication path to be an active node and uploads a program for performing a specific packet processing to the active node. If the packet transmission apparatus 12a on the node A, which is a wireless access point, is determined to be an active node, the packet transmission apparatus 12a receives a program sent by the terminal 10a and incorporates the program into the packet processing and then performs a priority control or the like on the packets transmitted between the source terminal 10a and the destination terminal 10b. The source terminal 10a and the destination terminal 10b are hereinafter simply called the terminals 10, the packet transmission apparatus 12a to 12d on the communication path are called the packet transmission apparatus 12.

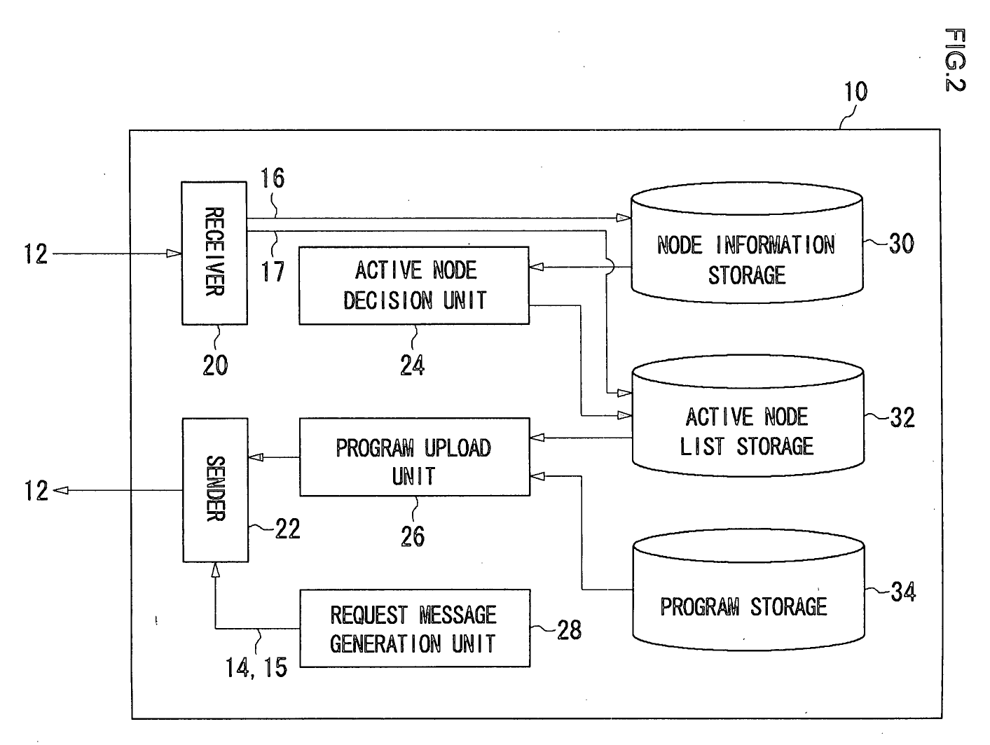

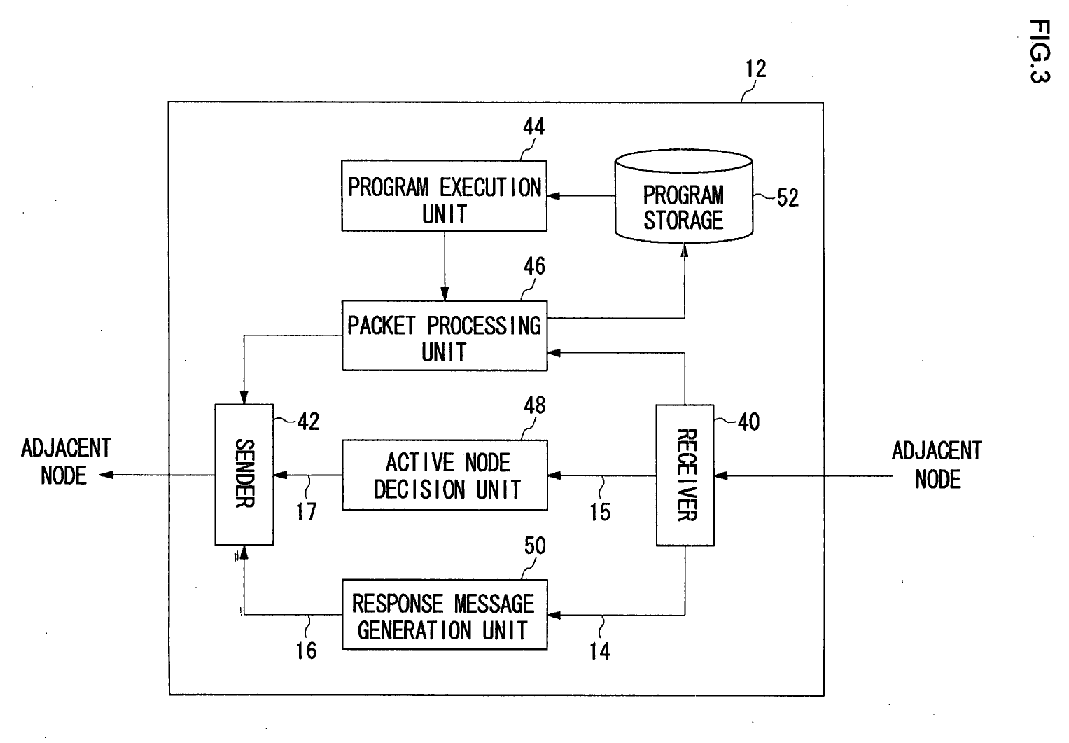

FIG. 2 is a block diagram of the terminal 10 and FIG. 3 is a block diagram of the packet transmission apparatus 12. These structures can be realized by hardware, such as a CPU in arbitrary computers, memory and other LSIs, or by software, such as a program or the like loaded in the memory, which has a packet processing function. In these figures, functions, which are realized by combinations of such hardware and software, are shown by blocks. It should be understood by those skilled in the art that these functional blocks can be realized by various modes such as hardware only, software only or a combination thereof.

Referring to the FIG. 2, the structure of the terminal 10 is explained. The terminal 10 performs one of two modes by switching over the modes: one mode in which the terminal 10 decides on a network node to be an active node and another mode in which the network nodes decide whether to be an active node. First, the mode in which the terminal 10 decides an active node is explained.

A request message generation unit 28 generates a node information request message 14 and a sender 22 sends it to the packet transmission apparatus 12. A receiver 20 receives a node information response message 16 from the packet transmission apparatus 12 and stores it in a node information storage 30.

An active node decision unit 24 decides active nodes according to the node information response messages 16 of the nodes, which have been collected and stored in the node information storage 30, and stores a list of the active nodes in an active node list storage 32.

A program upload unit 26 refers to the active node list stored in the active node list storage 32 and performs a process for uploading a predefined program stored in a program storage 34 to each active node. The program may be transmitted by FTP (File Transfer Protocol) or the like by the sender 22 or the program may be incorporated into a part of packet to be sent by the terminal 10 and transmitted by the sender 22.

In the mode in which the network node decides whether to be an active node, the request message generation unit 28 generates an active node decision request message 15 and the sender 22 sends it to the packet transmission apparatus 12. The receiver 20 receives an active node decision response message 17 from the packet transmission apparatus 12 on the node that determines to be an active node, and stores the node as one of active nodes in the active node list storage 32. The program upload unit 26 performs the same process as described above.

Referring to FIG. 3, the structure of the packet transmission apparatus 12 is explained. A receiver 40 receives a packet from an adjacent node on the communication path. The received packet may include the node information request message 14, the active node decision request message 15, communication data, program data or the like.

When the receiver 40 receives the node information request message 14, a response message generation unit 50 generates a node information response message 16 which contains a node type, a processing load, a processing capacity, a relative location from the terminal or the like, and a sender 42 sends the node information response message 16 as a packet back to the terminal 10.

When the receiver 40 receives the active node decision request message 15, an active node decision unit 48 decides whether to be an active node according to the communication requirement information included in the active node decision request message 15, such as a connection type of the terminal, a desired network quality, a media type of data to be transmitted or the like. If the node determines to be an active node, the active node decision unit 48 generates an active node decision response message 17 which contains the identification information of the node and the reason the node becomes to be an active node, and the sender 42 sends the active node decision response message 17 as a packet back to the terminal 10.

When the receiver 40 receives a communication data packet, a packet processing unit 46 performs a protocol-based processing on the packet, and the sender 42 forwards the processed packet to an adjacent node. When the receiver 40 receives a communication data packet with a program attached, the packet processing unit 46 separates the attached program data from the packet and stores the program data in a program storage 52, and then performs a protocol-based processing on the packet containing communication data only, and the sender 42 forwards the processed packet to the adjacent node. When the receiver 40 receives a packet containing a program only, the packet processing unit 46 simply retrieves the program data from the packet and stores it in the program storage 52.

When the node determines to be an active node, a program execution unit 44 executes the program stored in the program storage 52, and performs a priority control or the like on the packet transmission process by the packet processing unit 46. The program execution unit 44 may incorporate the program into a part of the packet processing by the packet processing unit 46. In a protocol-based processing by the packet processing unit 46, the control may be switched over to the program execution unit 44 and the program may be executed therein. The packet, which the packet processing unit 46 has processed and on which the program execution unit 44 has performed the priority control or the like, is forwarded to the adjacent node by the sender 42.

The program placement method of the active network by the terminal 10 and the packet transmission apparatus 12 according to the above-described configuration is now explained.

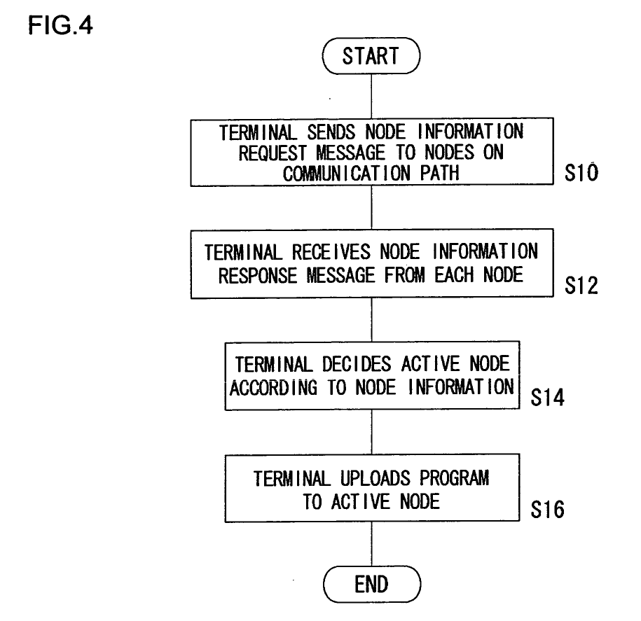

FIG. 4 is a flowchart showing a procedure employed by the terminal 10 for deciding an active node and uploading a program. The terminal 10 sends the node information request message 14 to a plurality of nodes on the communication path (S10). The terminal 10 receives the node information response message 16 from the packet transmission apparatus 12 on each node that has received the node information request message 14 (S12).

The node information response message 16 includes the node information, for instance information on a node type such as router, switch, wireless access point or the like, information on a processing load such as the current number of accepted flows or the packet processing speed at the node, information on a packet processing capacity such as hardware performance, the maximum number of acceptable flows, the maximum packet processing speed of the node, or information on the relative location of the node from the terminal such as a hop count, IP address or the like.

The terminal 10 decides on at least one of the plurality of the nodes on the communication path to be an active node according to the node information that has been collected from these nodes (S14), and the terminal 10 uploads an appropriate program to the active node (S16).

Some rules for determining the active node are now explained.

(A) The case in which the terminal 10 is connected to a wireless access point.

By referring to the collected node information, the terminal 10 decides on the node whose node type is a wireless access point to be an active node. The program for performing an appropriate packet processing depending on the difference in the bandwidth on wired or wireless transmission and the communication quality such as an error rate is uploaded to the active node. For instance, this program performs a processing on an application layer, such as content conversion according to the transmission bandwidth of the wireless link. The content conversion is, for instance, to reduce the resolution or the frame rate of an image according to the wireless bandwidth.

(B) The case in which the terminal 10 sends or receives media data such as real-time audio or motion pictures.

By referring to the collected node information, the terminal 10 decides on the node having a heavy processing load to be an active node. Since the node having a heavy processing load is very likely to be a bottleneck in transmitting media data, the node is determined to be an active node and a program for performing a priority control on real-time media packets is uploaded to the node and the node executes the program. For instance, the active node performs such a priority control that packets whose transmission quality requirement such as delay or delay jitter is strict are first transmitted. All nodes having a larger processing load than a predefined threshold may be determined to be active nodes. Only one node having the largest processing load among the nodes having a larger processing load than a predefined threshold may be determined to be an active node.

(C) The case in which an active node is determined according to the processing capacity of the nodes.

By referring to the collected node information, the terminal 10 decides on the node with a low processing capacity to be an active node. Since the node with a low processing capacity is likely to be a bottleneck in transmitting packets, the node is determined to be an active node and a program for utilizing the processing capacity is uploaded to the node and the node executes the program. For instance, the node performs a process to reserve network resources for packet transmission for the terminal 10 in advance, or restrict the admission of flows except for the flow of the terminal 10 by flow admission control. All nodes having a lower processing capacity than a predefined threshold may be determined to be active nodes. Only one node having the lowest processing capacity may be determined to be an active node.

(D) The case in which an active node is determined according to the relative location of the nodes.

By referring to the collected node information, the terminal 10 decides on the node with a small hop count from the terminal or close to the terminal to be an active node. The distance between the node and the terminal may be determined on the basis of the IP address of the node. For instance, the program for performing a priority control on packets sent or received by the terminal is uploaded to the active node and the active node executes the program.

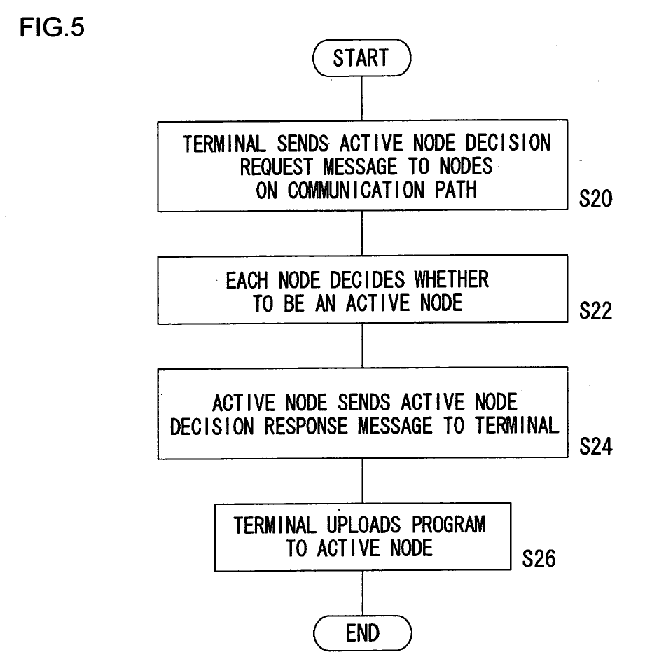

FIG. 5 is a flowchart showing a procedure by the packet transmission apparatus 12 for deciding whether to be an active node and receiving a program uploaded from the terminal 10. The terminal 10 sends the active node decision request message 15, which contains packet communication requirement information of the terminal 10, to a plurality of the nodes on the communication path (S20).

The active node decision request message 15 includes the packet communication requirement information, for instance, information on the terminal connection type such as access on a wired network or access via wireless network, information on a desired network quality such as an expected value for packet loss rate, delay, or jitter of the packets to be sent or received by the terminal, information on a media type of the data to be sent or received by the terminal such as text, still image, motion pictures, audio or the like.

Each of the nodes which have received the active node decision request message 15 decides whether to be an active node for the terminal 10 according to the terminal information (S22). If any node decides to be an active node, the active node sends an active node decision response message 17, which contains the identification information of this node and the reason for determining to be an active node, to the terminal 10 (S24). The terminal 10 uploads a program appropriate for the reason for determining to be an active node, which is found in the active node decision response message 17, to the active node (S26).

The reason for determining to be an active node is now explained.

(A) The case in which the connection type of the terminal 10 is wireless.

When the information on the connection type of the terminal 10, which is included in the active node decision request message 15, indicates wireless, and if the node is the wireless access point that directly communicates with the terminal 10, the node decides to be an active node. The program for performing an appropriate packet processing depending on the difference in the bandwidth of wired or wireless transmission or the communication quality such as an error rate is uploaded to the active node and the active node executes the program.

(B) The case in which an active node is determined according to a network quality and a media data type.

By referring to the user's network quality requirement and a media data type included in the active node decision request message 15, the node decides to be an active node if it is judged that the node cannot meet the quality requirement of the terminal 10 under the current packet processing load, but the node can perform a process to meet the quality requirement when the node becomes an active node. The program for performing a control to meet the quality requirement of the packets sent or received by the terminal is uploaded to the active node and the active node executes the program.

(C) The case in which the communication quality between the nodes is bad and the retransmission of the packets sent or received by the terminal 10 occurs frequently.

If the node is located at the end of a link with a low level of communication quality because of a high packet loss rate, the node decides to be an active node. The program for performing a retransmission control on packets within this link is uploaded to the active node and the active node executes the program. The nodes at both ends of the link with a bad communication quality may be active nodes or either of the nodes may be an active node.

According to the present embodiment, as has been described, the terminal that sends and receives packets collects the information of the network nodes on the packet transmission path and thereby the terminal can recognize which node is congested with packet flows or which node becomes a bottleneck in the packet transmission. The terminal can decide on a node to be an active node according to the node information and place a program for an active node effectively. The node for transmitting packets can obtain the requirement information of the communication by the terminal and decide on whether to be an active node and thereby instruct the terminal to upload the program for the active node.

Although the present invention has been described by way of exemplary embodiments, it should be understood that many changes and substitutions may be made by those skilled in the art without departing from the scope of the present invention which is defined by the appended claims. Some such alterations are stated as follows.

In the above explanation, the method by which the terminal determines an active node and the method by which the node determines whether to be an active node are described, however, the combination of these two methods may be used. Thereby, the program for the active node can be placed effectively, according to the situations of both the terminal side and the node side. In the above explanation, a router or an access point for transmitting packets is considered as an active node, however, a server for offering contents may be an active node.

What is claimed is:

1. A terminal comprising:
a sending unit which sends a request message for node information to a plurality of network nodes on a communication path;
a receiving unit which receives a response message including the node information from each of the network nodes which have received the request message;
a decision unit which decides on at least one of the plurality of the network nodes to be an active node according to the response message; and
an upload unit which uploads to the active node a program for performing a specific process on packets to be sent or received by the terminal.

2. The terminal of claim 1, wherein the receiving unit receives information on a communication method of the node as the response message, and the decision unit decides on a wireless communication node to be the active node, and the upload unit uploads to the active node a program for performing a packet processing to conform to a wireless communication quality.

3. The terminal of claim 1, wherein the receiving unit receives information on a processing load of the node as the response message, and the decision unit decides on a node with a relatively light processing load to be the active node, and the upload unit uploads to the active node a program for controlling priority on the packets to be sent or received by the terminal.

4. The terminal of claim 1, wherein the receiving unit receives information on a processing load of the node as the response message, and the decision unit decides on a node with a larger processing load than a predefined threshold to be the active node, and the upload unit uploads to the active node a program for performing a priority control on a packet processing according to a transmission quality requirement.

5. The terminal of claim 1, wherein the receiving unit receives information on a processing capacity of the node as the response message, and the decision unit decides on a node with a smaller processing capacity than a predefined threshold to be the active node, and the upload unit uploads to the active node a program for performing a priority control on the packets to be sent or received by the terminal.

6. The terminal of claim 1, wherein the receiving unit receives information on a relative location of the node from the terminal as the response message, and the decision unit decides on a node relatively close to the terminal to be the active node, and the upload unit uploads to the active node a program for performing a priority control on the packets to be sent or received by the terminal.

7. A packet transmission apparatus comprising:
a decision unit which decides whether to be an active node for the terminal in receiving a decision request message for an active node from a terminal;
a receiving unit which receives from the terminal a program for performing a specific process on packets to be sent or received by the terminal when the decision unit decides to be an active node;
a storage which stores the received program; and
an execution unit which executes the stored program by incorporating the program into a packet processing.

8. The apparatus of claim 7, wherein the decision unit decides to be an active node if the apparatus is a wireless access point for the terminal, and the execution unit executes a program for performing a process to conform to a wireless communication quality by incorporating the program into the packet processing.

9. The apparatus of claim 7, wherein the decision unit decides to be an active node if the apparatus can meet a network quality requested by the terminal, and the execution unit executes a program for performing a priority control on the packets to be sent or received by the terminal by incorporating the program into the packet processing.

10. The apparatus of claim 7, wherein the decision unit decides to be an active node if the apparatus is at an end of a link with a low level of communication quality, and the execution unit executes a program for performing a retransmission control on packets on the link by incorporating the program into the packet processing.

11. A program placement method comprising:
collecting node information from a plurality of network nodes on a communication path of packets to be sent or received by a terminal;
deciding on at least one of the plurality of the network nodes to be an active node according to the collected node information; and
uploading to the active node a program for performing a specific process on packets to be sent or received by the terminal.

12. The method of claim 11, wherein the collecting collects information on a communication method of the node, and the deciding decides on a wireless communication node to be the active node, and the uploading uploads to the active node a program for performing a packet processing to conform to a wireless communication quality.

13. The method of claim 11, wherein the collecting collects information on a processing load of the node, and the deciding decides on a node with a relatively light processing load to be the active node, and the uploading uploads to the active node a program for performing a priority control on the packets to be sent or received by the terminal.

14. The method of claim 11, wherein the collecting collects information on a processing load of the node, and the deciding decides on a node with a larger processing load than a predefined threshold to be the active node, and the uploading uploads to the active node a program for performing a priority control on a packet processing according to a transmission quality requirement.

15. The method of claim 11, wherein the collecting collects information on a processing capacity of the node, and the deciding decides on a node with a smaller processing capacity than a predefined threshold to be the active node, and the uploading uploads to the active node a program for performing a priority control on the packets to be sent or received by the terminal.

16. The terminal of claim 11, wherein the collecting collects information on a relative location of the node from the terminal, and the deciding decides on a node relatively close to the terminal to be the active node, and the uploading uploads to the active node a program for performing a priority control on the packets to be sent or received by the terminal.

17. A program placement method comprising:
receiving requirement information on packet communication of a terminal at a node on a communication path of packets to be sent or received by the terminal;
deciding whether to be an active node for the terminal according to the requirement information; and
receiving from the terminal a program for performing a specific process on packets to be sent or received by the terminal and incorporating the received program into a packet processing if it is decided to be an active node.

18. The method of claim 17, wherein the deciding decides to be the active node if the node is a wireless access point for the terminal, and the incorporating incorporates a program for performing a process to conform to a wireless communication quality into the packet processing.

19. The method of claim 17, wherein the deciding decides to be the active node if the node can meet a network quality requested by the terminal, and the incorporating incorporates a program for performing a priority control on the packets to be sent or received by the terminal into the packet processing.

20. The apparatus of claim 17, wherein the deciding decides to be the active node if the node is at an end of a link with a low level of communication quality, and the incorporating incorporates a program for performing a retransmission control on packets on the link into the packet processing.
